(19) United States
(12) Patent Application Publication
(10) Pub. No.: US 2004/0037010 A1
(43) Pub. Date: Feb. 26, 2004

(54) Magneto-resistance effect type head

(75) Inventor: Takashi Suda, Kanagawa (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/455,775

(22) Filed: Jun. 6, 2003

(30) Foreign Application Priority Data
Jun. 6, 2002 (JP) 2002-165683

(51) Int. Cl. G11B 5/39

(52) U.S. Cl. 360/313; 360/320; 29/603.14

(57) ABSTRACT

A magneto-resistance effect type head (MR head) is formed of a laminated structure by using a thin film forming technique. In the magneto-resistance effect type head, an insulating layer, a lower shield layer, a lower gap layer, a magnetic resistance effect layer, an upper gap layer, an upper shield layer, and a protective layer are layered in sequence on one end of a base plate. A fine concave-convex portion is formed by means of etching on one end face of the base plate of which side is adjacent to the insulating layer so that the insulating layer can strictly be adhered to the base plate. The concave-convex portion is formed by means of ion etching using Argon gas or the like so as to be a surface roughness in the range of 1 to 100 nm.

### FIELD OF THE INVENTION

The present invention relates to a magneto-resistance effect type head, more particularly to a magneto-resistance effect type head having an improved electromagnetic conversion characteristic in data-reproducing process of a magnetic tape.

### BACKGROUND OF THE INVENTION

Conventionally, a magnetic tape, which is a magnetic recording medium, had been widely used as a signal-recording tape for recording and/or reproducing data of signals. Recently, a proposal for a narrower track, which reduces a track width of the magnetic tape more, has been considered as a countermeasure to increase a recording density per unit area. To realize this proposal, “a narrower gap”, which reduces a magnetic gap more, has been required in a magnetic head which is used in magnetic recording/reproducing devices. Accordingly, a magneto-resistance effect type head capable of having the narrower gap by using a thin film forming technique has been widely used.

FIG. 1 is a cross sectional view showing the main part of the conventional magneto-resistance effect type head. As shown in FIG. 1, a conventional magneto-resistance effect type head 30 is consisted of a laminated structure by using the thin film forming technique. The laminated structure is constituted in following ways. An insulating layer 32, a lower shield layer 33, a lower gap layer 34, a magneto-resistance effect layer 35, an upper gap layer 36, an upper shield layer 37, and a protective layer 38 are layered in sequence on a base plate 31. Herein, the base plate 31 is made of a nonmagnetic material. The insulating layer 32 is made of an insulating material. The lower shield layer 33is made of a magnetic material. The lower gap layer 34 is made of a nonmagnetic material. The upper gap layer 36 is made of a nonmagnetic material. The upper shield layer 37 is made of a magnetic material. The protective layer 38 is made of an insulating material. Then, a portion sandwiched between the lower shield layer 33 and the upper shield layer 37 corresponds to a magnetic gap G as a reading portion of the magneto-resistance effect type head 30. Alumina titanium carbide (AlTiC:Al₂O₃.TiC) as a nonmagnetic material is commonly used for the base plate 31. Alumina (Al₂O₃) or silica (SiO₂) is used for the insulating layer 32.

However, a following drawback has been arisen when AlTiC is used for the base plate 31 of the conventional magneto-resistance effect type head 30 shown in FIG. 1. In data-reproducing process, when the magnetic tape slides on the magneto-resistance effect type head 30, a pressure is applied to the sliding face of the magnetic tape on the base plate 31. This causes the insulating layer 32 to be peeled off from the base plate 31 so that a chink is generated between the base plate 31 and the insulating layer 32.

Specifically, when the chink is generated between the base plate 31 and the insulating layer 32, a friction coefficient between the magnetic tape and the magneto-resistance effect type head 30 is increased. Consequently, a sliding characteristic of the magnetic tape is deteriorated so that the magneto-resistance effect type head 30 can not accurately read signals from the magnetic tape.

More specifically, when the magnetic tape slides on the magneto-resistance effect type head 30 in data-reproducing process, vibration occurs on said chink in response to a sliding action of the magnetic tape. Consequently, when the magneto-resistance effect type head 30 reads signals from the magnetic tape, noise is contained in the signals.

Accordingly, an object of the present invention is to provide the magneto-resistance effect type head such that the insulating layer is not peeled off from the base plate even though the pressure is applied to the surface where the magnetic tape slides thereon in data-reproducing process of the magnetic tape.

### SUMMARY OF THE INVENTION

The magneto-resistance effect type head of the present invention comprises a base plate made of a nonmagnetic material, an insulating layer made of an insulating material and layered on one end face of the base plate, a lower shield layer made of a magnetic material and layered on the insulating layer, a lower gap layer made of a nonmagnetic material and layered on the lower shield layer, a magnetic resistance effect layer layered on the lower gap layer, an upper gap layer made of a nonmagnetic material and layered on the magneto-resistance effect layer, an upper shield layer made of a magnetic material and layered on the upper gap layer, and a protective layer made of an insulating material and layered on the upper shield layer, wherein a concave-convex portion is formed on one end face of the base plate by means of etching.

According to the present invention, the concave-convex portion is formed on one end face of the base plate so that the insulating layer formed on the base plate can strictly be adhered to the base plate. Accordingly, the insulating layer is not peeled off from the base plate even though a pressure is applied to the surface where the magnetic tape slides thereon in data-reproducing process of the magnetic tape. Now, aforementioned “concave-convex” means a fine unevenness having a surface roughness (R max) in the range of 1 to 100 nm.

Next, the magneto-resistance effect type head with regard to the present invention is manufactured in following ways. After the concave-convex portion is formed by means of etching on one end face of the base plate made of a nonmagnetic material, the insulating layer made of an insulating material having a thickness preferably in the range of 15 to 30 μm is formed on the base plate as a base layer. Then, the lower shield layer, the lower gap layer, the magneto-resistance effect layer, the upper gap layer, the upper shield layer, and the protective layer are layered in sequence on one end face of said insulating layer. Herein, the lower shield layer is made of a magnetic material. The lower gap layer is made of a nonmagnetic material. The upper gap layer is made of a nonmagnetic material. The upper shield layer is made of a magnetic material. The protective layer is made of an insulating material. Specifically, after the concave-convex portion is formed, the insulating layer made of an insulating material is formed on the base plate as the base layer. Thereby, the insulating layer formed on the base plate can strictly be adhered to the base plate. In addition, the insulating layer is not peeled off from the base plate even though the pressure is applied to the surface where the magnetic tape slides thereon in data-reproducing process of the magnetic tape.

### BRIEF DESCRIPTION OF THE DRAWINGS

FIG. 1 is a cross sectional view showing the main part of the conventional magneto-resistance effect type head.

FIG. 2 is a cross sectional view showing the main part of the magneto-resistance effect type head of the present invention.

FIG. 3 is a perspective view of the magneto-resistance effect type head shown in FIG. 2.

FIG. 4A is a cross sectional view to explain a manufacturing method of the magneto-resistance effect type head shown in FIG. 2 by indicating a state that the concave-convex portion is formed on one end face of the base plate.

FIG. 4B is a cross sectional view followed by FIG. 4A to indicate a state that the insulating layer is formed on the base plate.

FIG. 4C is a cross sectional view followed by FIG. 4B to indicate a state that the lower shield layer and the lower gap layer are formed on the insulating layer.

FIG. 5A is a cross sectional view followed by FIG. 4C to indicate a state that the magneto-resistance effect layer and the upper gap layer are formed on the lower gap layer.

FIG. 5B is a cross sectional view followed by FIG. 5A to indicate a state that the upper shield layer is formed on the upper gap layer.

FIG. 5C is a cross sectional view followed by FIG. 5B to indicate a state that the protective layer is formed on the upper shield layer.

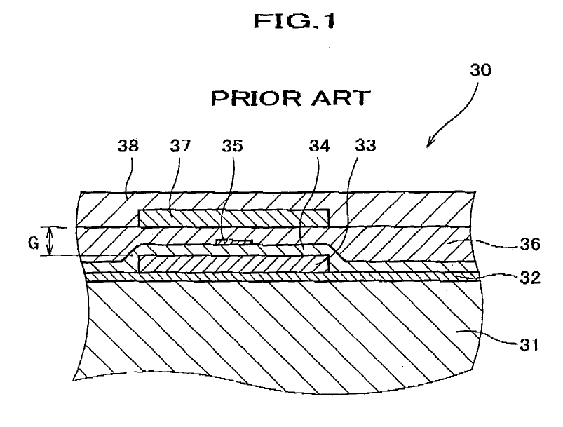

### DETAILED EXPLANATION OF THE PREFERRED EMBODIMENTS OF THE INVENTION

The embodiment of the present invention will be now properly described with reference to the accompanied drawings. The embodiment is assumed that alumina titanium carbide (AlTiC:Al₂O₃ TiC) is used for a base plate of a magneto-resistance effect type head. A structure of the magneto-resistance effect type head with regard to the present invention will be described.

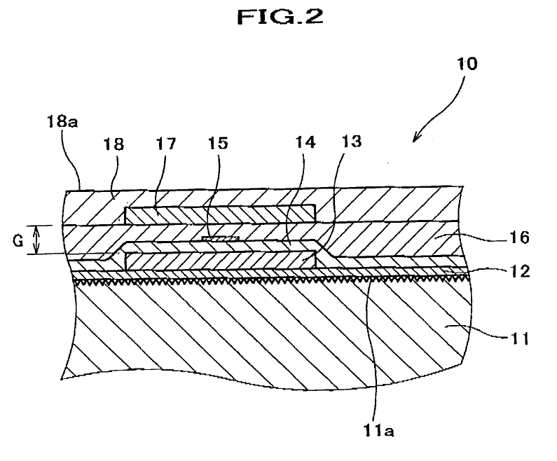

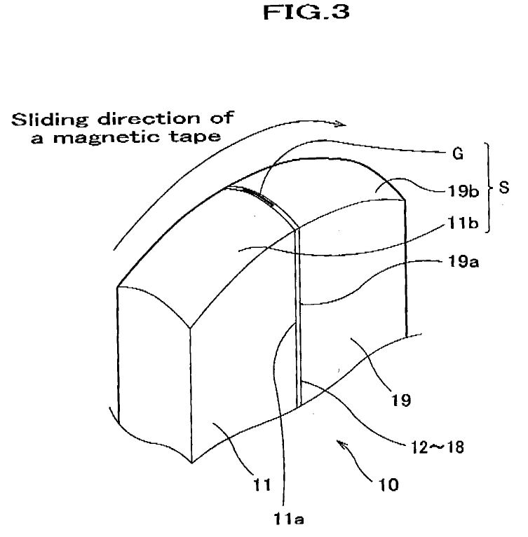

FIG. 2 is a cross sectional view showing the main part of the magneto-resistance effect type head with regard to the present invention. FIG. 3 is a perspective view of the magneto-resistance effect type head shown in FIG. 2. Herein, a thickness of every layer shown in FIG. 2 is drawn with an enlargement for better understanding. As shown in FIG. 2, the magneto-resistance effect type head (hereinafter referred to as “MR head”) is consisted of a laminated structure by using a thin film forming technique.

Now, aforementioned laminated structure is constituted in following ways. An insulating layer 12 is formed as a base layer on one end face 11a of the base plate 11. Then, a lower shield layer 13, a lower gap layer 14, a magneto-resistance effect layer 15, an upper gap layer 16, an upper shield layer 17, and a protective layer 18 are layered in sequence on the insulating layer 12. Herein, a portion sandwiched between the lower shield layer 13 and the upper shield layer 17 corresponds to a magnetic gap G as a reading portion of the MR head 10.

A protective plate 19 (shown in FIG. 3) is connected to one end face 18a (shown in FIG. 2) of the protective layer 18. As shown in FIG. 2 and FIG. 3, the insulating layer 12, the lower shield layer 13, the lower gap layer 14, the magneto-resistance effect layer 15, the upper gap layer 16, the upper shield layer 17, and the protective layer 18 are sandwiched between the one end face 19a of the protective plate 19 and the one end face 11a of the base plate 11.

As shown in FIG. 3, a top face 11b, which is one end face of the base plate 11, and a top face 19b, which is one end face of the protective plate 19b, are formed into a curved face. The top face 11b and the top face 19b are a part of a sliding face S of the magnetic tape, wherein the magnetic tape slides on the MR head 10 in data-reproducing process of the magnetic tape. The sliding face S is formed into a surface of a gentle arc along the sliding direction of the magnetic tape. Said magnetic gap G as a reading portion of the MR head is exposed to the sliding face S of the magnetic tape. When the magnetic tape passed over the magnetic gap G, the magnetic gap G reads signals recorded as a magnetic transition on the magnetic tape. Now, the magnetic gap G reads said signals by the magneto-resistance effect layer 15.

When data are reproduced from the magnetic tape, a sense current as a steady-state current is flowed in the magneto-resistance effect layer 15. The magnetic gap G reads signals recorded on the magnetic tape by detecting a resistance change in the magneto-resistance effect layer 15 as an amount of voltage change. The base plate 11 is formed of AlTiC (Al₂O₃ TiC) as a nonmagnetic material. One end face 11a of the base plate 11 is approximately a rectangular shape. A fine concave-convex portion having a surface roughness (R max) in the range of 1 to 100 nm is formed on one end face 11a by means of etching.

As shown in FIG. 3, a top face 11b of the base plate 11 is a part of the sliding face S of the magnetic tape together with a top face 19b of the protective plate 19. The insulating layer 12 is formed of alumina (Al₂O₃) or silica (SiO₂) as the insulating material. The insulating layer 12 is the base layer having a thickness in the range of 15 to 30 μm. The lower shield layer 13 and the upper shield layer 17 are formed of a polycrystalline ferrite such as Fe—Si-AL alloy (Sendust), Ni—Fe alloy (Permalloy), and Ni—Zn alloy (hematolite) as the magnetic material. The lower gap layer 14 and the upper gap layer 16 are formed of alumna (Al₂O₃) as a nonmagnetic material as one example. The magneto-resistance effect layer 15 is consisted of a laminated structure wherein a non-magnetic layer (SHUNT layer) is layered on a soft magnetic layer (SAL layer), and a magneto-resistance effect layer (MR layer) is layered on the non-magnetic layer (SHUNT layer) as one example. Herein, the soft magnetic layer (SAL layer) is formed of Ni—Fe—Nb alloy. The non-magnetism layer (SHUNT layer) is formed of tantalum (Ta). And the magneto-resistance effect layer (MR layer) is formed of Ni—Fe alloy (permalloy). The magneto-resistance effect layer 15 is a part of the magnetic gap G together with the lower gap layer 14 and the upper gap layer 16.

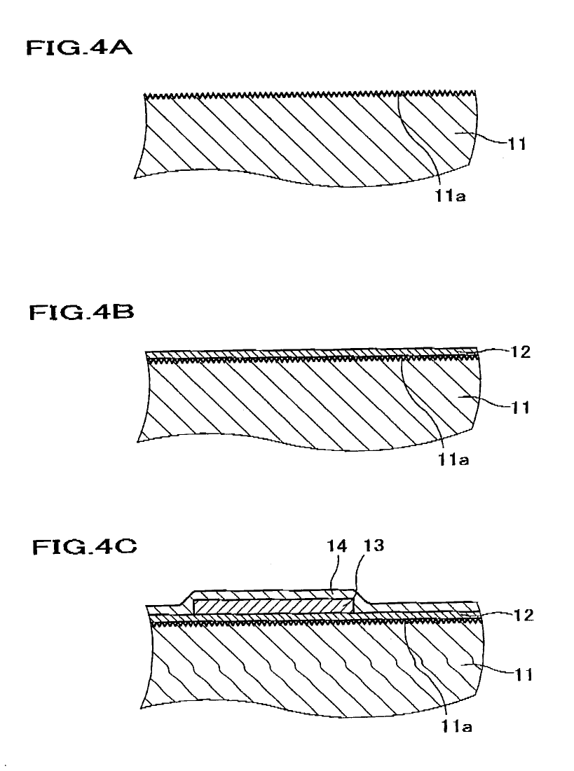

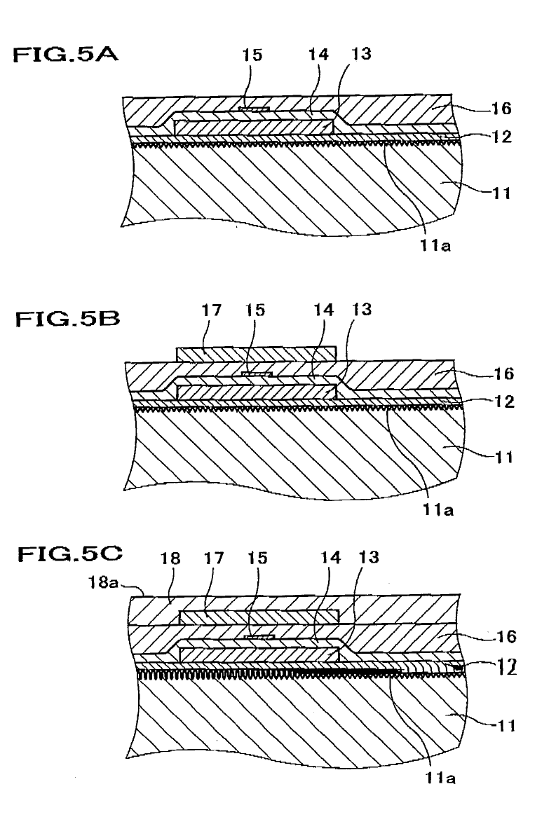

The protective layer 18 is formed of alumina (Al₂O₃), silica (SiO₂), or the like in the same way as said insulating layer 12 is. Next, descriptions will be made to explain the manufacturing method of aforementioned MR head of the present invention with reference to FIGS. 4A, 4B, 4C, 5A, 5B, and 5C. FIG. 4A through FIG. 5C are cross sectional views to explain the manufacturing method of MR head 10.

As shown in FIG. 4A, a fine concave-convex portion is formed by means of etching on one end face 11a of the base plate 11. The fine concave-convex portion is formed by means of ion etching using Argon gas or the like so as to be the surface roughness (R max) in the range of 1 to 100 nm.

Next, as shown in FIG. 4B, the insulating layer 12 is formed on one end face 11a of the base plate 11 by means of sputtering. Since the fine concave-convex portion is formed on one end face 11a of the base plate 11, the insulating layer 12 can strictly be adhered to the base plate 11. Next, as shown in FIG. 4C, after the lower shield layer 13 is formed on the insulating layer 12 by means of metal plating, the lower gap layer 14 is formed on the lower shield layer 13 by means of sputtering.

Next, as shown in FIG. 5A, the magneto-resistance effect layer 15 and the upper gap layer 16 are formed on the upper gap layer 14 in sequence by means of sputtering. Then, as shown in FIG. 5B, the upper shield layer 17 is formed on the upper gap layer 16 by means of metal plating.

Finally, as shown in FIG. 5C, the protective layer 18 is formed on the upper shield layer 17 by means of sputtering. Then, as shown in FIG. 3, the protective plate 19 is connected to one end face 18a of the protective layer 18. As finishing process, the top face 11b of the base plate 11 and the top face 19b of the protective plate 19 are ground so that the sliding face S of the magnetic tape is formed into a surface of a gentle arc.

As described above, according to the MR head 10 of the present invention, the concave-convex portion is formed on one end face 11a of the base plate 11 by means of etching. Thereby, the insulating layer 12 formed on one end face 11a of the base plate 11 can strictly be adhered to the base plate 11. Consequently, the insulating layer 12 is not peeled off from one end face 11a of the base plate 11 even though the pressure is applied to the surface S where the magnetic tape slides on the MR head 10 in data-reproducing process of the magnetic tape.

What is claimed is;

1. A magneto-resistance effect type head, comprising:
a base plate made of a nonmagnetic material;
an insulating layer made of an insulating material and layered on one end face of the base plate;
a lower shield layer made of a magnetic material and layered on the insulating layer;
a lower gap layer made of a nonmagnetic material and layered on the lower shield layer;
a magneto-resistance effect layer layered on the lower gap layer;
an upper gap layer made of a nonmagnetic material and layered on the magneto-resistance effect layer;
an upper shield layer made of a magnetic material and layered on the upper gap layer; and
a protective layer made of an insulating material and layered on the upper shield layer,
wherein a concave-convex portion is formed by means of etching on one end face of said base plate of which side is adjacent to the insulating layer.

2. The magneto-resistance effect type head according to claim 1, wherein said base plate is made of alumina titanium carbide (Al₂O₃ TiC).

3. The magneto-resistance effect type head according to claim 1, wherein said concave-convex portion formed on one end face of said base plate has a surface roughness (R max) in the range of 1 to 100 nm.

4. The magneto-resistance effect type head according to claim 2, wherein said concave-convex portion formed on one end face of said base plate has a surface roughness (R max) in the range of 1 to 100 nm.

5. The magneto-resistance effect type head according to claim 1, wherein said concave-convex portion is formed by means of etching on one end face of said base plate of which side is adjacent to the insulating layer.

6. The magneto-resistance effect type head according to claim 2, wherein said concave-convex portion is formed by means of etching on one end face of said base plate of which side is adjacent to the insulating layer.

7. The magneto-resistance effect type head according to claim 3, wherein said concave-convex portion is formed by means of etching on one end face of said base plate of which side is adjacent to the insulating layer.

8. The magneto-resistance effect type head according to claim 4, wherein said concave-convex portion is formed by means of etching on one end face of said base plate of which side is adjacent to the insulating layer.

9. The magneto-resistance effect type head according to claim 1, wherein said insulating layer is formed as a layer having a thickness in the range of 15 to 30 μm.

10. The magneto-resistance effect type head according to claim 2, wherein said insulating layer is formed as a layer having a thickness in the range of 15 to 30 μm.

11. The magneto-resistance effect type head according to claim 3, wherein said insulating layer is formed as a layer having a thickness in the range of 15 to 30 μm.

12. The magneto-resistance effect type head according to claim 4, wherein said insulating layer is formed as a layer having a thickness in the range of 15 to 30 μm.

13. The magneto-resistance effect type head according to claim 8, wherein said insulating layer is formed as a layer having a thickness in the range of 15 to 30 μm.

14. A manufacturing method of the magneto-resistance effect type head, said method comprising the steps of;
forming a concave-convex portion on the one end face of a base plate by means of etching;
forming an insulating layer made of an insulating material as a base layer having a thickness in the range of 15 to 30 μm on the concave-convex portion of the base plate;
layering a lower shield layer made of a magnetic material on the insulating layer;
layering a lower gap layer made of a nonmagnetic material on the lower shield layer;
layering a magneto-resistance effect layer on the lower gap layer;
layering an upper gap layer made of a nonmagnetic material on the magneto-resistance effect layer;
layering an upper shield layer made of a magnetic material on the upper gap layer;
layering a protective layer made of an insulating material on the upper shield layer.

15. The manufacturing method of the magneto-resistance effect type head according to claim 14, further comprising a step wherein a protective plate is connected to said protective layer.

16. The manufacturing method of the magneto-resistance effect type head according to claim 15, wherein said base plate is made of alumina titanium carbide (Al₂O₃ TiC).

17. The manufacturing method of the magneto-resistance effect type head according to claim 15, wherein a surface roughness (R max) of said concave-convex portion is kept in the range of 1 to 100 nm.

18. The manufacturing method of the magneto-resistance effect type head according to claim 16, wherein a surface roughness (R max) of said concave-convex portion is kept in the range of 1 to 100 nm.

19. The manufacturing method of the magneto-resistance effect type head according to claim 14, wherein said concave-convex portion is formed by means of ion etching.

20. The manufacturing method of the magneto-resistance effect type head according to claim 18, wherein said concave-convex portion is formed by means of ion etching.
